(19) United States
(12) Patent Application Publication
(10) Pub. No.: US 2026/0028167 A1
(43) Pub. Date: Jan. 29, 2026

(54) ELECTRODE PLATE TRANSFER DEVICE

(71) Applicant: SK On Co., Ltd., Seoul (KR)

(72) Inventors: Han Yeob KIM, Daejeon (KR); Cheol Ho JUNG, Daejeon (KR); Gyu Ik CHOI, Daejeon (KR)

(21) Appl. No.: 19/280,106

(22) Filed: Jul. 25, 2025

(30) Foreign Application Priority Data
Jul. 25, 2024 (KR) 10-2024-0098627
Jul. 8, 2025 (KR) 10-2025-0091728

(51) Int. Cl. B65D 61/00; B65D 85/30; H01M 10/04

(52) U.S. Cl. CPC B65D 61/00; B65D 85/30; H01M 10/0404

(57) ABSTRACT

The present disclosure relates to an electrode plate transfer device comprising: a support plate over which a plurality of electrode plates are stacked; and a plurality of support walls spaced apart from each other on the support plate, and bent to respectively face a plurality of corner edges to each form an inner bent surface and an outer bent surface, wherein each of the plurality of support walls includes: a first frame located at an edge of the support plate and forming at least one of the inner bent surface or the outer bent surface; and a second frame which is in contact with the first frame, and of which at least a part forms the inner bent surface.

### CROSS-REFERENCE TO RELATED PATENT APPLICATION

The present disclosure claims priority under 35 U.S.C. § 119(a) to Korean patent application number 10-2024-0098627, filed on Jul. 25, 2024 and Korean patent application number 10-2025-0091728, filed on Jul. 8, 2025, the entire disclosures of which are incorporated herein by reference.

### BACKGROUND OF THE INVENTION

### 1. Field

Various embodiments of the present disclosure generally relate to an electrode plate transfer device.

### 2. Description of the Related Art

A battery cell is formed in a form in which cathode plates, separators, and anode plates are stacked and immersed in an electrolyte solution, and an electrode assembly included in such a battery cell is formed in which electrode plates including a cathode plate or an anode plate are alternately stacked with a separator therebetween.

During a manufacturing process, as the electrode plates are received and transferred in a magazine, the electrode plates are subject to vibration, acceleration, deceleration, and in severe cases, collision. This can result in a poor quality battery cell including an electrode assembly manufactured with deformed electrode plates. Therefore, there is a need for a method to increase the stability during the transfer of electrode plates in the manufacturing process.

The above description is provided solely to facilitate the understanding of the background art of the technical spirits disclosed herein, and therefore should not be construed as prior art known to those skilled in the art of the present disclosure.

### SUMMARY OF THE INVENTION

First, according to one aspect of the present disclosure, the problem to be solved is to improve the efficiency of a manufacturing process.

Second, according to another aspect of the present disclosure, the problem to be solved is to improve the stability of a manufacturing process.

Third, according to another aspect of the present disclosure, the problem to be solved is to improve the stability during the transfer of electrode plates in a manufacturing process.

Fourth, according to another aspect of the present disclosure, the problem to be solved is to prevent or mitigate deformed electrode plates from being used in the manufacture of an electrode assembly, thereby preventing or mitigating defects in a battery cell.

Various embodiments of the present disclosure may be widely applied in the green technology fields such as electric vehicles, battery charging stations, energy storage systems (ESSs), and other technologies using batteries such as photovoltaics and wind power. In addition, various embodiments of the present disclosure may also be used for eco-friendly mobility, including electric and hybrid vehicles, to reduce air pollution and greenhouse gas emissions to prevent or mitigate climate change.

An electrode plate transfer device according to an embodiment of the present disclosure, which carries a plurality of electrode plates each of which includes a plurality of side edges and a plurality of corner edges connecting the plurality of side edges, may include: a support plate over which the plurality of electrode plates are stacked; and a plurality of support walls spaced apart from each other on the support plate, and bent to respectively face the plurality of corner edges to each form an inner bent surface and an outer bent surface, wherein each of the plurality of support walls includes: a first frame located at an edge of the support plate and forming at least one of the inner bent surface or the outer bent surface; and a second frame which is in contact with the first frame, and of which at least a part forms the inner bent surface.

In an embodiment, the second frame may have hardness lower than hardness of the first frame.

In an embodiment, the second frame may include Teflon.

In an embodiment, each of the plurality of support walls may further include a third frame in contact with the second frame and forming a part of the outer bent surface.

In an embodiment, the third frame may include stainless steel (SUS).

In an embodiment, the plurality of side edges may include: a plurality of first side edges extending in a first direction and having a first length; and a plurality of second side edges extending in a second direction intersecting the first direction, and having a second length the same as or different from the first length. The first frame may face one of the plurality of first side edges, and form a part of the inner bent surface and another part of the outer bent surface.

In an embodiment, the second frame may include: a first portion of which at least a part faces one of the plurality of second side edges in the first direction; and a second portion which extends from the first portion in the second direction and of which at least a part is in contact with the first frame.

In an embodiment, the second frame may include: a first surface facing one of the plurality of second side edges in the first direction; and a second surface opposite the first surface in the first direction. The third frame may be in contact with the second surface of the second frame.

In an embodiment, the second frame may form another part of the inner bent surface and a further part of the outer bent surface.

In an embodiment, the plurality of side edges may include: a plurality of first side edges extending in a first direction and having a first length; and a plurality of second side edges extending in a second direction intersecting the first direction, and having a second length the same as or different from the first length. Each of the plurality of corner edges may include a chamfer portion. The first frame may include: a third portion of which at least a part faces the chamfer portion in the first direction; and a fourth portion which extends from the third portion in the first direction, and of which at least a part faces one of the plurality of first side edges and the chamfer portion in the second direction. The first frame may form a part of the inner bent surface and another part of the outer bent surface.

In an embodiment, the second frame may form another part of the inner bent surface.

In an embodiment, the second frame may include: a first surface facing one of the plurality of second side edges in the first direction; and a second surface opposite the first surface in the first direction. The third frame may be in contact with the second surface of the second frame.

In an embodiment, the plurality of side edges may include: a plurality of first side edges extending in a first direction and having a first length; and a plurality of second side edges extending in a second direction intersecting the first direction, and having a second length the same as or different from the first length. The first frame may face one of the plurality of first side edges and one of the plurality of second side edges, and may form a part of the inner bent surface and entirety of the outer bent surface.

In an embodiment, at least a part of the second frame may face the one of the plurality of second side edges in the first direction, and the second frame may form another part of the inner bent surface.

In an embodiment, the second frame may include: a first surface facing the one of the plurality of second side edges in the first direction; and a second surface opposite the first surface in the first direction. The first frame may be in contact with the second surface of the second frame.

In an embodiment, the plurality of side edges may include: a plurality of first side edges extending in a first direction and having a first length; and a plurality of second side edges extending in a second direction intersecting the first direction, and having a second length the same as or different from the first length. The first frame may face one of the plurality of first side edges and one of the plurality of second side edges, and may form entirety of the outer bent surface.

In an embodiment, the second frame may face the one of the plurality of first side edges and the one of the plurality of second side edges, and may form entirety of the inner bent surface.

In an embodiment, the second frame may include: a (1-1)-th surface facing the one of the plurality of second side edges in the first direction; a (1-2)-th surface facing the one of the plurality of first side edges in the second direction; a (2-1)-th surface opposite the (1-1)-th surface in the first direction; and a (2-2)-th surface opposite the (1-2)-th surface in the second direction. The first frame may be in contact with the (2-1)-th surface in the first direction, and may be in contact with the (2-2)-th surface in the second direction.

First, according to an embodiment of the present disclosure, the efficiency of a manufacturing process may be improved.

Second, according to another embodiment of the present disclosure, the stability of a manufacturing process may be improved.

Third, according to another embodiment of the present disclosure, the stability may be improved during the transfer of electrode plates in a manufacturing process.

Fourth, according to another embodiment of the present disclosure, defects in a battery cell may be prevented or mitigated by preventing or mitigating the use of deformed electrode plates in the manufacture of an electrode assembly.

### BRIEF DESCRIPTION OF THE DRAWINGS

FIG. 1 is a perspective view schematically illustrating electrode assembly manufacturing apparatus including an electrode plate transfer device according to the present disclosure;

FIG. 2 is a perspective view schematically illustrating detailed components of a supply unit shown in FIG. 1;

FIG. 3 is a perspective view illustrating an electrode plate transfer device according to an embodiment of the present disclosure;

FIG. 4 is a plan view of the electrode plate transfer device shown in FIG. 3;

FIG. 5 is a perspective view illustrating an electrode plate transfer device according to another embodiment of the present disclosure;

FIG. 6 is a plan view of the electrode plate transfer device shown in FIG. 5;

FIG. 7 is a perspective view of an electrode plate transfer device according to another embodiment of the present disclosure;

FIG. 8 is a plan view of the electrode plate transfer device shown in FIG. 7;

FIG. 9 is a perspective view of an electrode plate transfer device according to another embodiment of the present disclosure; and

FIG. 10 is a plan view of the electrode plate transfer device shown in FIG. 9.

### DETAILED DESCRIPTION

Hereinafter, specific descriptions in accordance with the present disclosure are provided with reference to the accompanying drawings. It is noted, however, that the descriptions are merely illustrative and the present disclosure is not limited to specific embodiments described in this specification. Terms used in this specification are merely used for illustration, and are not used to limit embodiments provided herein.

Singular forms in the present disclosure are intended to include plural forms as well, unless the context clearly indicates otherwise. Throughout the specification, in a case where a certain portion “includes” a certain component, the portion may further include another component without excluding another component unless otherwise stated. “At least one of X, Y, or Z” and “at least one selected from a group consisting of X, Y, and Z” may be interpreted as X only, Y only, Z only, or any combination of two or more of X, Y, and Z (for example, XY, YZ, ZX, and XYZ).

In a case where a component is “connected” to another component, the components may be “directly connected” or the components may be “indirectly connected” with another element interposed therebetween. Terms such as “first” and “second” may be used to describe various components. These terms are used to describe a plurality of components which perform the same function but are disposed in different locations, or to distinguish one component from another component. Therefore, a first component may refer to a second component within a range without departing from the scope disclosed herein.

Hereinafter, embodiments of the disclosure may be described with reference to schematic diagrams (and intermediate structures) of the present disclosure. Here, it should be noted that, in the accompanying drawings, reference numerals are added to components, so that the same components have the same reference numerals as much as possible. Further, it should be expected that the shapes shown in the figures may vary in practice depending, for example, on tolerances and/or applied techniques. Accordingly, the embodiments of the present disclosure are illustrated with components conceptualized for convenience of illustration and are not to be construed as being necessarily limited to particular shapes or sizes. Likewise, the shapes illustrated in the drawings might not depict actual shapes of areas of apparatus, and embodiments of the present disclosure are not necessarily limited thereto.

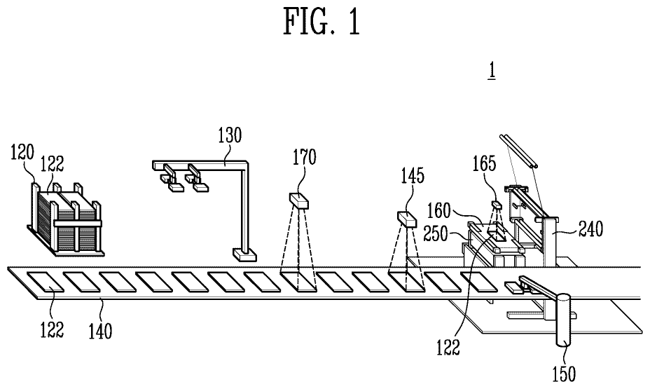

FIG. 1 is a perspective view schematically illustrating electrode assembly manufacturing apparatus 1 including an electrode plate transfer device according to the present disclosure.

Referring to FIG. 1, the electrode assembly manufacturing apparatus 1 may include a supply unit 120, an electrode plate moving unit 130, an electrode plate transfer unit 140, an alignment inspection unit 145, an electrode plate transport unit 150, an electrode plate stacking unit 160, an electrode plate alignment inspection unit 165, a quality inspection unit 170, a separator stacking unit 240, and a moving unit 250.

In addition, although not shown in FIG. 1, the electrode assembly manufacturing apparatus 1 may further include a separator supply portion (not shown) and a controller (not shown).

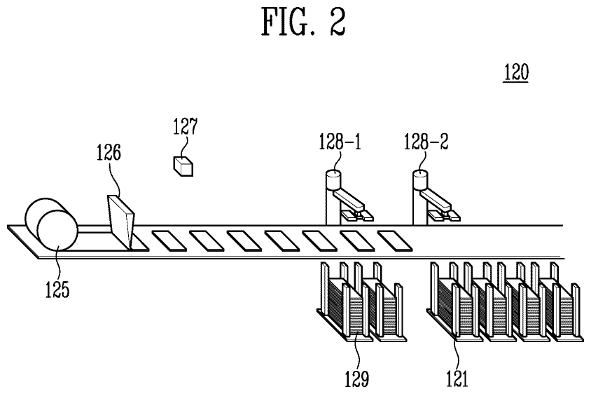

The supply unit 120 may supply electrode plates 122 which are composed of cathode plates or anode plates. Further, the supply unit 120 may include various components to efficiently transfer the electrode plates 122. For example, the supply unit 120 may include an electrode plate transfer device (see 121 in FIG. 2) for carrying at least one or more electrode plates 122. The supply unit 120 may move the electrode plate transfer device 121 to a preset region. The electrode plate transfer device 121 may accurately deliver the electrode plates 122 to the locations required for a manufacturing process.

FIG. 2 is a perspective view schematically illustrating detailed components of the supply unit 120 shown in FIG. 1.

Referring to FIG. 2, the supply unit 120 may be configured to load a plurality of electrode plates 122 onto the electrode plate transfer device 121.

The supply unit 120 may include an electrode roll 125, a cutting mechanism 126, a detection sensor 127, an electrode plate discharge mechanism 128-1, an electrode plate receiving mechanism 129, an electrode plate loading mechanism 128-2, and the electrode plate transfer device 121.

The electrode roll 125 may be an electrode rolled into a roll shape.

The cutting mechanism 126 may cut a part of the electrode roll 125 to form at least one electrode plate 122 when one side of the electrode roll 125 is unwound and moved by a conveyor belt or the like. The detection sensor 127 may detect whether the electrode

plates 122 formed by the cutting mechanism 126 are out of shape. For example, the detection sensor 127 may be configured as a visual sensor to detect whether the electrode plates 122 are formed in a preset shape which is undamaged.

The electrode plate discharge mechanism 128-1 may be configured as a mechanism capable of gripping and transporting the electrode plates 122 and discharging the damaged electrode plates 122 outside the supply unit 120.

The electrode plate receiving mechanism 129 may receive the deformed electrode plates 122 discharged by the electrode plate discharge mechanism 128-1, and the electrode plates 122 received in the electrode plate receiving mechanism 129 may be discarded.

The electrode plate loading mechanism 128-2 may be configured as a mechanism capable of gripping and transporting the electrode plates 122, and may load the electrode plates 122 which are not discharged externally by the electrode plate discharge mechanism 128-1 onto the electrode plate transfer device 121.

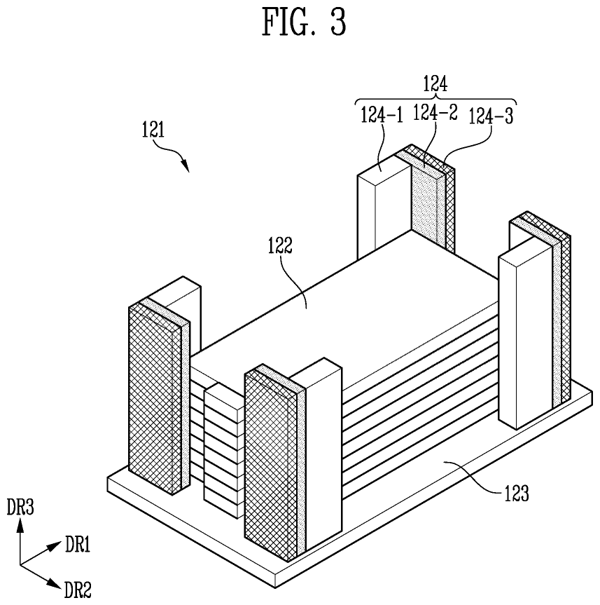

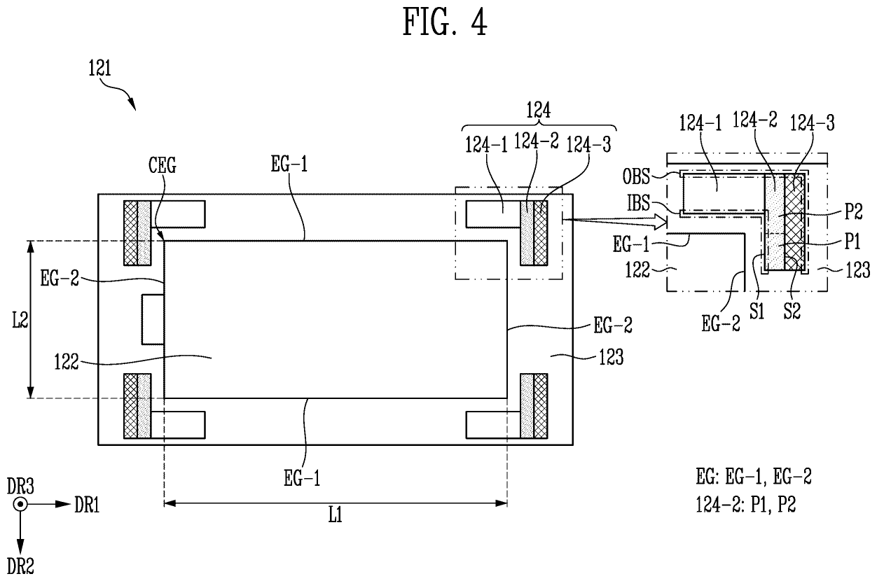

FIG. 3 is a perspective view illustrating the electrode plate transfer device 121 according to an embodiment of the present disclosure. FIG. 4 is a plan view of the electrode plate transfer device 121 shown in FIG. 3.

Referring to FIGS. 3 and 4, the electrode plate transfer device 121 according to an embodiment of the present disclosure may include a support plate 123 and a plurality of support walls 124.

Each of the plurality of electrode plates 122 may include a plurality of side edges EG and a plurality of corner edges CEG connecting the plurality of side edges EG.

The plurality of side edges EG may include a plurality of first side edges EG-1 extending in a first direction DR1 and having a first length L1, and a plurality of second side edges EG-2 extending in a second direction DR2 intersecting the first direction DR1 and having a second length L2 which may be the same as or different from the first length L1. In the drawings of the present disclosure, the first length L1 is shown as being greater than the second length L2, but embodiments might not necessarily be limited thereto. For example, the first length L1 and the second length L2 may be the same, or the first length L1 may be shorter than the second length L2. However, for convenience of description, the following description will focus on the case where the first length L1 is greater than the second length L2, as shown in the drawings. Hereinafter, the first direction DR1 may refer to a direction

in which the electrode plate transfer device 121 transfers the plurality of electrode plates 122. The second direction DR2 may be a direction intersecting the direction in which the electrode plate transfer device 121 transfers the plurality of electrode plates 122. A third direction DR3 may be a direction which intersects both the first direction DR1 and the second direction DR2.

The plurality of electrode plates 122 may be stacked over the support plate 123. The support plate 123 may have a structure which allows the plurality of electrode plates 122 to be loaded and supported. For example, the support plate 123 may be formed to have a plate shape having an area larger than an area of each of the plurality of electrode plates 122, such that the plurality of electrode plates 122 may be stably loaded onto the electrode plate transfer device 121. The support plate 123 may include a material having adequate strength and durability to allow the plurality of electrode plates 122 to be stably loaded.

The plurality of support walls 124 may be spaced apart from each other on the support plate 123. The plurality of support walls 124 may be spaced apart from each other at respective corners of the support plate 123, thereby stably supporting the plurality of electrode plates 122. The plurality of support walls 124 may be formed to be higher than the stacking height of the plurality of electrode plates 122. The plurality of support walls 124 may prevent or mitigate the plurality of electrode plates 122 from moving in the first direction DR1 or the second direction DR2 on one surface of the support plate 123 and detaching from the support plate 123.

The plurality of support walls 124 may be bent to respectively face the plurality of corner edges CEG of the plurality of electrode plates 122 and to each form an inner bent surface IBS and an outer bent surface OBS.

Each of the plurality of support walls 124 may include a first frame 124-1 located at an edge of the support plate 123 and forming at least one of the inner bent surface IBS or the outer bent surface OBS, and a second frame 124-2 which is in contact with the first frame 124-1 and of which at least a part forms the inner bent surface IBS.

The first frame 124-1 may include aluminum, but embodiments of the present disclosure are not necessarily limited thereto. For example, the first frame 124-1 may include a material having characteristics such as light weight, high strength, excellent corrosion resistance, and ease of processing. However, for convenience of description, the following description will focus on the case where the first frame 124-1 includes aluminum. When the first frame 124-1 includes aluminum, the weight of the electrode plate transfer device 121 may be reduced, which not only allows the plurality of electrode plates 122 to be transferred with greater agility, but also reduces the energy consumption required for the transfer.

The second frame 124-2 may have the hardness which is lower than the hardness of the first frame 124-1. The second frame 124-2 may include a material which is relatively soft compared to the materials of the first frame 124-1 and the plurality of electrode plates 122.

In one example, the second frame 124-2 may include Teflon, although embodiments of the present disclosure are not necessarily limited thereto. In another example, the second frame 124-2 may include a polymeric material having a low coefficient of friction and excellent durability, such as perfluoroalkoxy alkane (PFA), fluorinated ethylene propylene (FEP), ethylene tetrafluoroethylene (ETFE), polyvinylidene fluoride (PVDF), and ultra-high molecular weight polyethylene (UHMWPE). The second frame 124-2 may reduce wear of the plurality of electrode plates 122 upon contact by minimizing or reducing friction between the second frame 124-2 and the plurality of electrode plates 122, thereby being capable of supporting the plurality of electrode plates 122 without damage.

Each of the plurality of support walls 124 may further include a third frame 124-3 in contact with the second frame 124-2 and forming a part of the outer bent surface OBS. The third frame 124-3 may have rigidity to support the second frame 124-2. The third frame 124-3 may be located to face the plurality of electrode plates 122 with the second frame 124-2 interposed between the third frame 124-3 and the plurality of electrode plates 122, and may stably support the second frame 124-2 in the first direction DR1.

The third frame 124-3 may be located in various ways depending on the shape or position of the second frame 124-2. For example, when the second frame 124-2 has a straight or curved shape, one surface of the third frame 124-3 may have a straight or curved shape depending on the shape of the second frame 124-2. Also, when the second frame 124-2 is displaced to one side, the third frame 124-3 may also be displaced to one side in consideration of the position of the second frame 124-2. The third frame 124-3 may optimize the interaction with the plurality of electrode plates 122 based on the shape or position of the second frame 124-2. The third frame 124-3 may effectively support the plurality of electrode plates 122 while allowing the functionality of the second frame 124-2 to be stably maintained.

The third frame 124-3 may include stainless steel (SUS), but embodiments of the present disclosure are not necessarily limited thereto. For example, the third frame 124-3 may include a variety of metals and alloys, such as aluminum alloys, titanium alloys, copper alloys, carbon steel, alloy steel, and the like.

The third frame 124-3 may withstand the force or pressure generated when the second frame 124-2 comes into contact with the plurality of electrode plates 122, and may maintain a fixed state without deformation. To this end, the third frame 124-3 may include a material having high rigidity. For example, stainless steel is highly durable and strong, and resistant to corrosion, thereby being capable of maintaining the performance thereof even after long-term use. In addition, stainless steel has excellent mechanical strength, which may provide the stable supporting force even when subjected to the external force or pressure. The third frame 124-3 may fix the second frame 124-2 to prevent or mitigate damage to the plurality of electrode plates 122 and enhance the reliability and durability of the electrode plate transfer device 121.

Referring to FIG. 4, the first frame 124-1 may face one of the plurality of first side edges EG-1 and may form a part of the inner bent surface IBS and another part of the outer bent surface OBS of one of the support walls 124.

The second frame 124-2 may include a first portion P1 of which at least a part faces one of the plurality of second side edges EG-2 in the first direction DR1, and a second portion P2 which extends from the first portion P1 in the second direction DR2, and of which at least a part is in contact with the first frame 124-1.

The second frame 124-2 may include a first surface S1 facing one of the plurality of second side edges EG-2, and a second surface S2 opposite the first surface S1 in the first direction DR1. The third frame 124-3 may be in contact with the second surface S2 of the second frame 124-2.

The first to third frames 124-1, 124-2, and 124-3 may be connected to each other and integrated into a single unit. The second frame 124-2 and the third frame 124-3 may have the same length and may be arranged side by side in the first direction DR1.

The second frame 124-2 may form another part of the inner bent surface IBS and a further part of the outer bent surface OBS of one of the support walls 124.

The inner bent surface IBS of the support wall 124 shown in FIGS. 3 and 4 may be formed by an inner surface of the first frame 124-1 and a part of an inner surface of the second frame 124-2. Additionally, the outer bent surface OBS of the support wall 124 may be formed by an outer surface of the first frame 124-1, one side surface of the second frame 124-2, and one side surface and an outer surface of the third frame 124-3. As used herein, “inner surface” refers to a surface located on the inner side with respect to a direction from the center (not shown) of the plurality of electrode plates 122 toward the plurality of support walls 124. Further, the term “outer surface” refers to a surface located on the outer side with respect to the direction from the center of the plurality of electrode plates 122 toward the plurality of support walls 124. Further, the term “side surface” refers to the remaining surface, other than the inner and outer surfaces, which has the smallest thickness among the respective surfaces of each of the first to third frames 124-1, 124-2, and 124-3.

According to the configuration as described above, the first frame 124-1 may restrict movement of the plurality of electrode plates 122 in the second direction DR2. The second frame 124-2 may restrict movement of the plurality of electrode plates 122 in the first direction DR1 and may absorb impacts between the second frame 124-2 and the plurality of electrode plates 122, thereby preventing or at least minimizing or reducing deformation of the plurality of electrode plates 122. Further, the second frame 124-2 may minimize or reduce friction between the second frame 124-2 and the plurality of electrode plates 122, thereby preventing, minimizing or reducing wear of the plurality of electrode plates 122. The third frame 124-3 may complement the rigidity of the second frame 124-2 to stably support and fix the second frame 124-2 such that deformation or breakage of the second frame 124-2 does not occur even when the plurality of electrode plates 122 apply impacts to the second frame 124-2 in the first direction DR1 during transport.

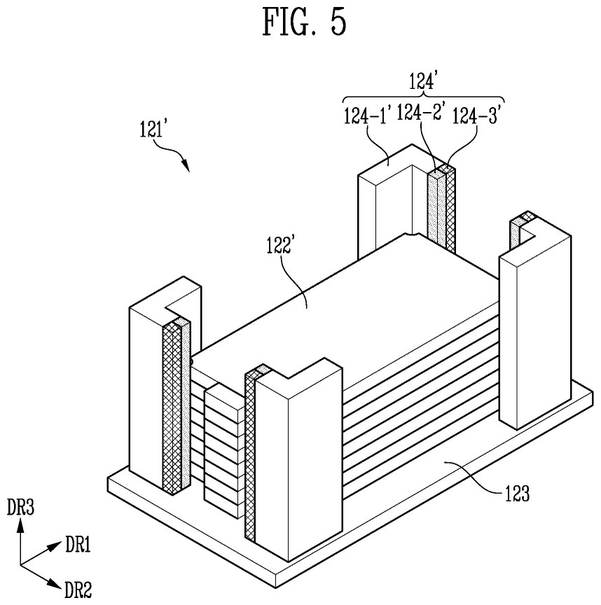

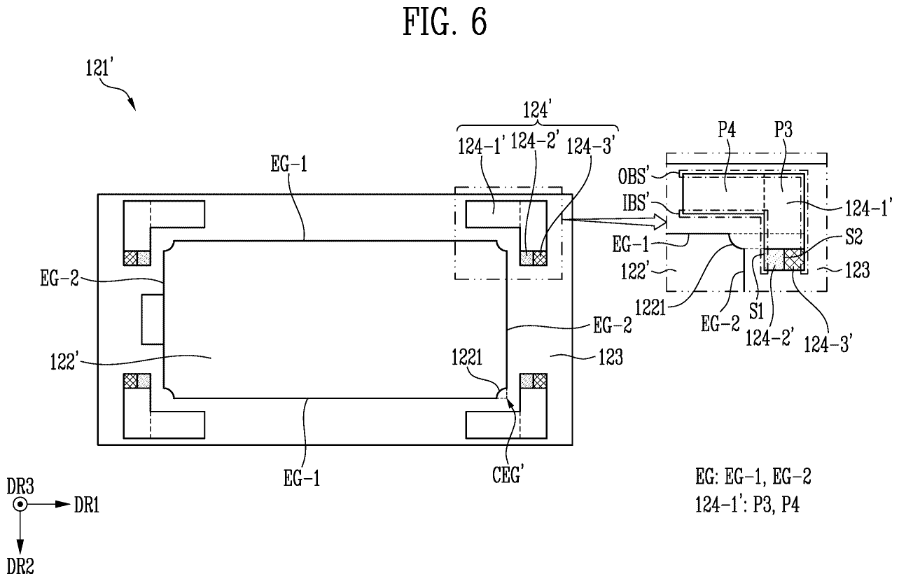

FIG. 5 is a perspective view illustrating an electrode plate transfer device 121′ according to another embodiment of the present disclosure. FIG. 6 is a plan view of the electrode plate transfer device 121′ shown in FIG. 5.

Referring to FIGS. 5 and 6, the electrode plate transfer device 121′ according to another embodiment of the present disclosure may include the support plate 123 and a plurality of support walls 124′.

Each of a plurality of electrode plates 122′ may include the plurality of side edges EG and a plurality of corner edges CEG′ connecting the plurality of side edges EG.

The support plate 123 and the plurality of side edges EG of the electrode plate 122′ may be configured similarly to the support plate 123 and the plurality of side edges EG described with reference to FIGS. 3 and 4, and thus will not be described in detail hereinafter.

However, each of the plurality of corner edges CEG′ may further include a chamfer portion 1221 which is not present in the plurality of corner edges CEG described with reference to FIGS. 3 and 4.

The chamfer portion 1221 may have a rounded shape in a plane defined by the first direction DR1 and the second direction DR2 of the plurality of electrode plates 122′. By forming the chamfer portion 1221 at each corner edge CEG′ of each of the plurality of electrode plates 122′, each corner of each of the plurality of electrode plates 122′ may form a smooth curved shape with no sharp angles. The rounded shape of the chamfer portion 1221 may improve the structural strength of the electrode plates 122′ and reduce damage which may occur during use.

The plurality of support walls 124′ may be spaced apart from each other on the support plate 123. The plurality of support walls 124′ may be spaced apart from each other at respective corners of the support plate 123, thereby stably supporting the plurality of electrode plates 122′. The plurality of support walls 124′ may prevent or mitigate the plurality of electrode plates 122′ from moving in the first direction DR1 and the second direction DR2 on one surface of the support plate 123 and detaching from the support plate 123.

The plurality of support walls 124′ may be bent to respectively face the plurality of corner edges CEG′ of the plurality of electrode plates 122′ and to each form an inner bent surface IBS' and an outer bent surface OBS′.

Each of the plurality of support walls 124′ may include a first frame 124-1′, a second frame 124-2′, and a third frame 124-3′.

The first to third frames 124-1′, 124-2′, and 124-3′ illustrated in FIGS. 5 and 6 have different shapes from the first to third frames 124-1, 124-2, and 124-3 described with reference to FIGS. 3 and 4, but are substantially the same in material and function, and therefore the above-mentioned description is incorporated by reference and only the differences will be described hereinafter.

The first frame 124-1′ is located at the edge of the support plate 123, and may form a part of the inner bent surface IBS' and a part of the outer bent surface OBS' of one of the support walls 124′.

The second frame 124-2′ may be in contact with the first frame 124-1′ and may form another part of the inner bent surface IBS′.

The third frame 124-3′ may be in contact with the second frame 124-2′ and may form another part of the outer bent surface OBS′.

The first frame 124-1′ may include a third portion P3 of which at least a part faces the chamfer portion 1221 in the first direction DR1, and a fourth portion P4 which extends from the third portion P3 in the first direction DR1 and of which at least a part faces one of the plurality of first side edges EG-1 and the chamfer portion 1221 in the second direction DR2.

The second frame 124-2′ may include the first surface S1 facing one of the plurality of second side edges EG-2 and the second surface S2 opposite the first surface S1 in the first direction DR1. The third frame 124-3′ may be in contact with the second surface S2 of the second frame 124-2′.

The third portion P3 of the first frame 124-1′ may face the chamfer portion 1221 in the first direction DR1, while the second frame 124-2′ might not face the chamfer portion 1221 in the first direction DR1. In other words, the plurality of second side edges EG-2 of the plurality of electrode plates 122′ might not face the first frame 124-1′ in the first direction DR1, but may face the second frame 124-2′ in the first direction DR1.

The inner bent surface IBS' of the support wall 124′ shown in FIGS. 5 and 6 may be formed by an inner surface of the first frame 124-1′ and an inner surface of the second frame 124-2′. Further, the outer bent surface OBS' of the support wall 124′ may be formed by an outer surface of the first frame 124-1′ and an outer surface of the third frame 124-3′. As used herein, “inner surface” refers to a surface located on the inner side with respect to a direction from the center (not shown) of the plurality of electrode plates 122′ toward the plurality of support walls 124′. Further, “outer surface” refers to a surface located on the outer side with respect to the direction from the center of the plurality of electrode plates 122′ toward the plurality of support walls 124′.

According to the configuration as described above, the first frame 124-1′ may restrict movement of the plurality of electrode plates 122′ in the second direction DR2. The second frame 124-2′ may restrict movement of the plurality of electrode plates 122′ in the first direction DR1 and may absorb impacts between the second frame 124-2′ and the plurality of electrode plates 122′, thereby preventing or at least minimizing or reducing deformation of the plurality of electrode plates 122′. Further, the second frame 124-2′ may minimize or reduce friction between the second frame 124-2′ and the plurality of electrode plates 122′, thereby preventing, minimizing or reducing wear of the plurality of electrode plates 122′. The third frame 124-3′ may complement the rigidity of the second frame 124-2′ in the first direction DR1 to stably support and fix the second frame 124-2′ such that deformation or breakage of the second frame 124-2′ does not occur even when the plurality of electrode plates 122′ apply impacts to the second frame 124-2′ in the first direction DR1 during transport.

Furthermore, even when the plurality of electrode plates 122′ move in the first direction DR1, approach and eventually collide with at least one of the plurality of support walls 124′ during transport, the chamfer portions 1221 of the plurality of electrode plates 122′ might not collide with any of the first frame 124-1′ and the second frame 124-2′. Instead, the second side edges EG-2 of the plurality of electrode plates 122′ may collide with the second frame 124-2′ capable of absorbing impacts, thereby preventing or mitigating deformation or breakage of the plurality of electrode plates 122′.

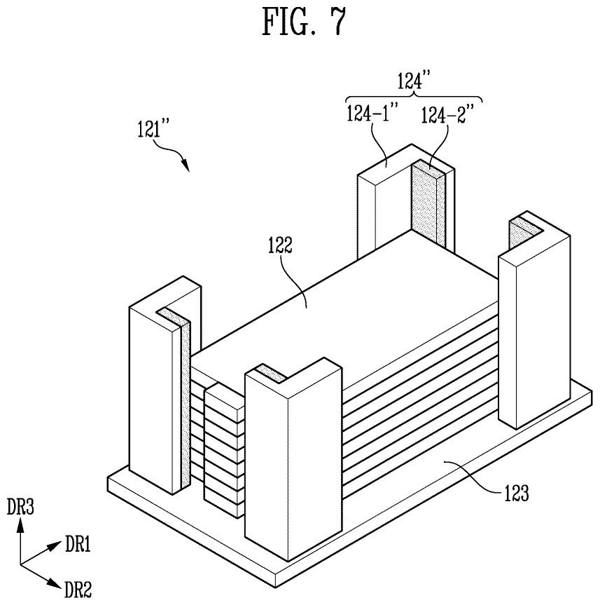

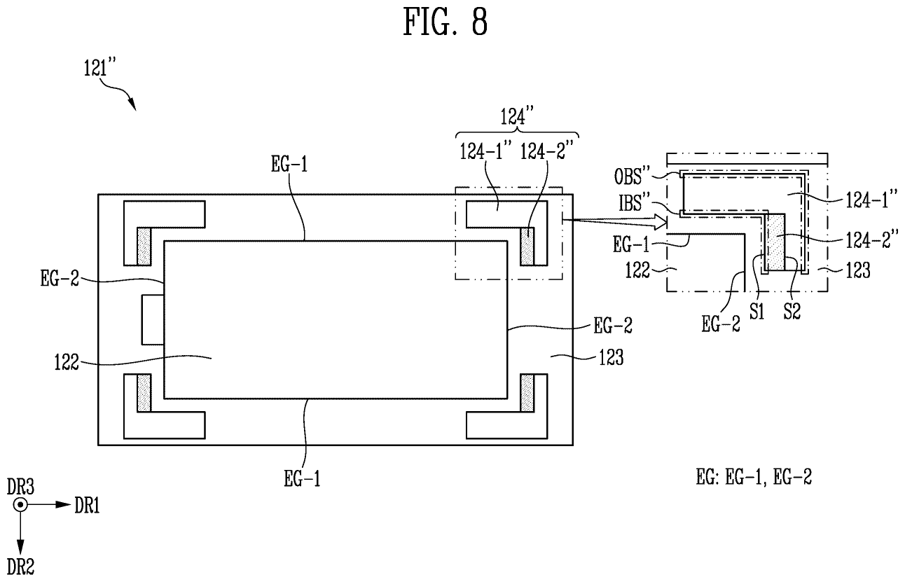

FIG. 7 is a perspective view of an electrode plate transfer device 121″ according to another embodiment of the present disclosure. FIG. 8 is a plan view of the electrode plate transfer device 121″ shown in FIG. 7.

Referring to FIGS. 7 and 8, the electrode plate transfer device 121″ according to another embodiment of the present disclosure may include the support plate 123 and a plurality of support walls 124″.

The plurality of electrode plates 122 and the support plate 123 may be configured similarly to the plurality of electrode plates 122 and the support plate 123 described with reference to FIGS. 3 and 4, and therefore will not be described in detail hereinafter.

The plurality of support walls 124″ may be bent to respectively face the plurality of corner edges CEG of the plurality of electrode plates 122 and to each form an inner bent surface IBS″ and an outer bent surface OBS″.

Each of the plurality of support walls 124″ may include a first frame 124-1″ and a second frame 124-2″.

The first and second frames 124-1″ and 124-2″ illustrated in FIGS. 7 and 8 have different shapes from the first and second frames 124-1 and 124-2 described with reference to FIGS. 3 and 4, but are substantially the same in material and function, and therefore the above-mentioned description is incorporated by reference and only the differences will be described hereinafter.

The first frame 124-1″ may face one of the plurality of first side edges EG-1 and one of the plurality of second side edges EG-2 and form a part of the inner bent surface IBS″ and the entirety of the outer bent surface OBS″ of one of the support walls 124″.

At least a part of the second frame 124-2″ may face one of the plurality of second side edges EG-2 in the first direction DR1 and the second frame 124-2″ may form another part of the inner bent surface IBS″.

The second frame 124-2″ may include the first surface S1 facing one of the second side edges EG-2, and the second surface S2 opposite the first surface S1 in the first direction DR1. The first frame 124-1″ may be in contact with the second surface S2 of the second frame 124-2″. The first and second frames 124-1″ and 124-2″ may be connected to each other and integrated into a single unit.

The inner bent surface IBS″ of the support wall 124″ shown in FIGS. 7 and 8 may be formed by a part of an inner surface of the first frame 124-1″ and the entirety of an inner surface of the second frame 124-2″. Further, the outer bent surface OBS″ of the support wall 124″ may be formed by the entirety of an outer surface of the first frame 124-1″. As used herein, “inner surface” refers to a surface located on the inner side with respect to a direction from the center (not shown) of the plurality of electrode plates 122 toward the plurality of support walls 124″. Furthermore, “outer surface” refers to a surface located on the outer side with respect to the direction from the center of the plurality of electrode plates 122 toward the plurality of support walls 124″.

According to the configuration as described above, the first frame 124-1″ may restrict movement of the plurality of electrode plates 122 in the second direction DR2. The second frame 124-2″ may restrict movement of the plurality of electrode plates 122 in the first direction DR1 and may absorb impacts between the second frame 124-2″ and the plurality of electrode plates 122, thereby preventing or at least minimizing or reducing deformation of the plurality of electrode plates 122. Further, the second frame 124-2″ may minimize or reduce friction between the second frame 124-2″ and the plurality of electrode plates 122, thereby preventing, minimizing or reducing wear of the plurality of electrode plates 122. The first frame 124-1″ may complement the rigidity of the second frame 124-2″ in the first direction DR1 to stably support and fix the second frame 124-2″ such that deformation or breakage of the second frame 124-2″ does not occur even when the plurality of electrode plates 122 apply impacts to the second frame 124-2″ in the first direction DR1 during transport.

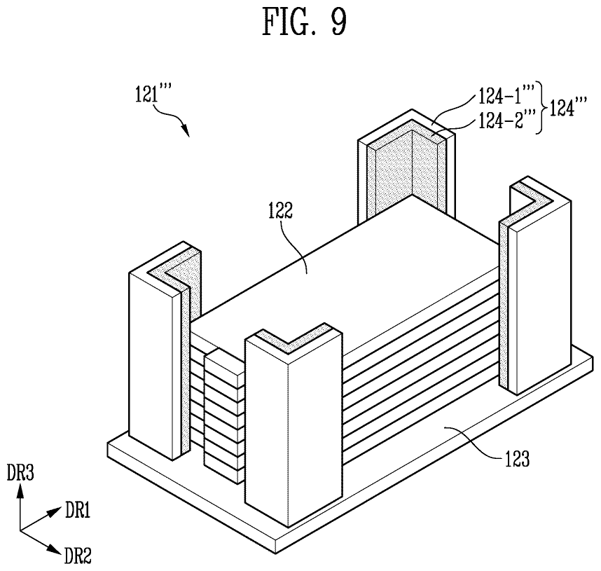

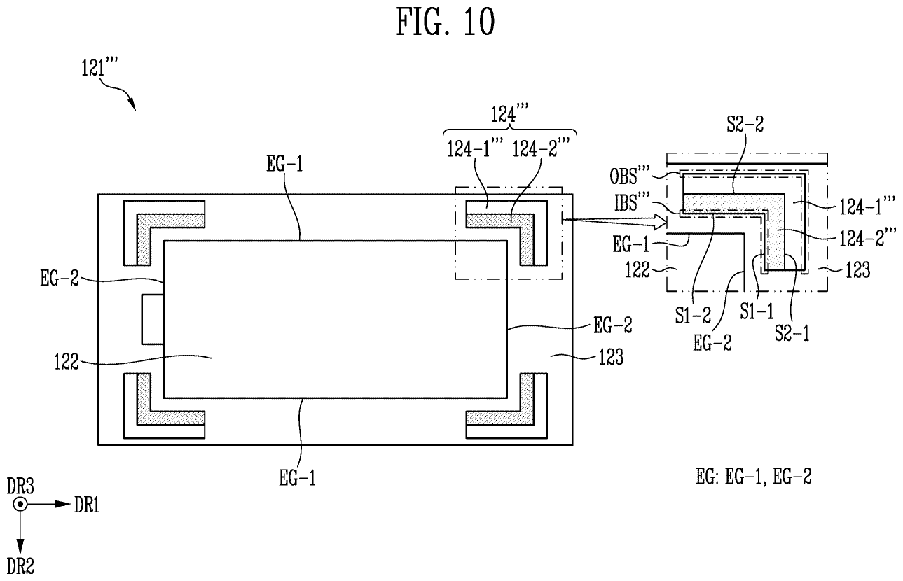

FIG. 9 is a perspective view of an electrode plate transfer device 121′″ according to another embodiment of the present disclosure. FIG. 10 is a plan view of the electrode plate transfer device 121′″ shown in FIG. 9.

Referring to FIGS. 9 and 10, the electrode plate transfer device 121′″ according to another embodiment of the present disclosure may include the support plate 123 and a plurality of support walls 124″.

The plurality of electrode plates 122 and the support plate 123 may be configured similarly to the plurality of electrode plates 122 and the support plate 123 described with reference to FIGS. 3 and 4, and therefore will not be described in detail hereinafter.

The plurality of support walls 124″ may be bent to respectively face the plurality of corner edges CEG of the plurality of electrode plates 122 and to each form an inner bent surface IBS′″ and an outer bent surface OBS′″.

Each of the plurality of support walls 124′″ may include a first frame 124-1″ and a second frame 124-2′″.

The first and second frames 124-1′″ and 124-2′″ illustrated in FIGS. 9 and 10 have different shapes from the first and second frames 124-1 and 124-2 described with reference to FIGS. 3 and 4, but are substantially the same in material and function, and therefore the above-mentioned description is incorporated by reference and only the differences will be described hereinafter.

The first frame 124-1′″ may face one of the plurality of first side edges EG-1 and one of the plurality of second side edges EG-2 and form the entirety of the outer bent surface OBS″ of one of the support walls 124′″.

The second frame 124-2″ may face one of the plurality of first side edges EG-1 and one of the plurality of second side edges EG-2, and form the entirety of the inner bent surface IBS″ of one of the support walls 124′″.

The second frame 124-2″ may include a (1-1)-th surface S1-1 facing one of the second side edges EG-2 in the first direction DR1, a (1-2)-th surface S1-2 facing one of the first side edges EG-1 in the second direction DR2, a (2-1)-th surface S2-1 opposite the (1-1)-th surface S1-1 in the first direction DR1, and a (2-2)-th surface S2-2 opposite the (1-2)-th surface S1-2 in the second direction DR2. The first frame 124-1″ may be in contact with the (2-1)-th surface S2-1 of the second frame 124-2″ in the first direction DR1, and may be in contact with the (2-2)-th surface S2-2 of the second frame 124-2′″ in the second direction DR2. The first and second frames 124-1′″ and 124-2′″ may be connected to each other and integrated into a single unit.

The inner bent surface IBS″ of the support wall 124′″ shown in FIGS. 9 and 10 may be formed by the entirety of an inner surface of the second frame 124-2′″. Further, the outer bent surface OBS′″ of the support wall 124′″ may be formed by the entirety of an outer surface of the first frame 124-1′″. As used herein, “inner surface” refers to a surface located on the inner side with respect to a direction from the center (not shown) of the plurality of electrode plates 122 toward the plurality of support walls 124′″. Furthermore, “outer surface” refers to a surface located on the outer side with respect to the direction from the center of the plurality of electrode plates 122 toward the plurality of support walls 124′″.

According to the configuration as described above, the second frame 124-2″ may restrict movement of the plurality of electrode plates 122 in the first and second directions DR1 and DR2 and may absorb impacts between the second frame 124-2′″ and the plurality of electrode plates 122, thereby preventing or at least minimizing or reducing deformation of the plurality of electrode plates 122. Further, the second frame 124-2″ may minimize or reduce friction between the second frame 124-2′″ and the plurality of electrode plates 122, thereby preventing, minimizing or reducing wear of the plurality of electrode plates 122. The first frame 124-1′″ may complement the rigidity of the second frame 124-2″ in the first and second directions DR1 and DR2 to stably support and fix the second frame 124-2′″ such that deformation or breakage of the second frame 124-2′″ does not occur even when the plurality of electrode plates 122 apply impacts to the second frame 124-2′″ in the first and second directions DR1 and DR2 during transport.

Because the present disclosure may be implemented in various forms, the scope of the present disclosure is not limited to the above-described embodiments. Therefore, as long as a modified embodiment includes components of the appended claims of the present disclosure, it should be considered to fall within the scope of the present disclosure.

What is claimed is:

1. An electrode plate transfer device carrying a plurality of electrode plates each of which includes a plurality of side edges and a plurality of corner edges connecting the plurality of side edges, the electrode plate transfer device comprising:
a support plate over which the plurality of electrode plates are stacked; and
a plurality of support walls spaced apart from each other on the support plate, and bent to respectively face the plurality of corner edges to each form an inner bent surface and an outer bent surface,
wherein each of the plurality of support walls comprises:
a first frame located at an edge of the support plate and forming at least one of the inner bent surface or the outer bent surface; and
a second frame in contact with the first frame, at least a part of the second frame forming the inner bent surface.

2. The electrode plate transfer device of claim 1, wherein the second frame has hardness lower than hardness of the first frame.

3. The electrode plate transfer device of claim 1, wherein the second frame includes Teflon.

4. The electrode plate transfer device of claim 1, wherein each of the plurality of support walls further includes a third frame in contact with the second frame and forming a part of the outer bent surface.

5. The electrode plate transfer device of claim 4, wherein the third frame includes stainless steel (SUS).

6. The electrode plate transfer device of claim 4, wherein the plurality of side edges comprise:
a plurality of first side edges extending in a first direction and having a first length; and
a plurality of second side edges extending in a second direction intersecting the first direction, and having a second length the same as or different from the first length, and
wherein the first frame faces one of the plurality of first side edges, and forms a part of the inner bent surface and another part of the outer bent surface.

7. The electrode plate transfer device of claim 6, wherein the second frame comprises:
a first portion of which at least a part faces one of the plurality of second side edges in the first direction; and
a second portion which extends from the first portion in the second direction and of which at least a part is in contact with the first frame.

8. The electrode plate transfer device of claim 6, wherein the second frame comprises:
a first surface facing one of the plurality of second side edges in the first direction; and
a second surface opposite the first surface in the first direction, and
wherein the third frame is in contact with the second surface of the second frame.

9. The electrode plate transfer device of claim 6, wherein the second frame forms another part of the inner bent surface and a further part of the outer bent surface.

10. The electrode plate transfer device of claim 4, wherein the plurality of side edges comprise:
a plurality of first side edges extending in a first direction and having a first length; and
a plurality of second side edges extending in a second direction intersecting the first direction, and having a second length the same as or different from the first length,
wherein each of the plurality of corner edges includes a chamfer portion,
wherein the first frame comprises:
a third portion of which at least a part faces the chamfer portion in the first direction; and
a fourth portion which extends from the third portion in the first direction, and of which at least a part faces one of the plurality of first side edges and the chamfer portion in the second direction, and
wherein the first frame forms a part of the inner bent surface and another part of the outer bent surface.

11. The electrode plate transfer device of claim 10, wherein the second frame forms another part of the inner bent surface.

12. The electrode plate transfer device of claim 10, wherein the second frame comprises:
a first surface facing one of the plurality of second side edges in the first direction; and
a second surface opposite the first surface in the first direction, and
wherein the third frame is in contact with the second surface of the second frame.

13. The electrode plate transfer device of claim 1, wherein the plurality of side edges comprise:
a plurality of first side edges extending in a first direction and having a first length; and
a plurality of second side edges extending in a second direction intersecting the first direction, and having a second length the same as or different from the first length, and
wherein the first frame faces one of the plurality of first side edges and one of the plurality of second side edges, and forms a part of the inner bent surface and entirety of the outer bent surface.

14. The electrode plate transfer device of claim 13, wherein at least a part of the second frame faces the one of the plurality of second side edges in the first direction, and the second frame forms another part of the inner bent surface.

15. The electrode plate transfer device of claim 13, wherein the second frame comprises:
a first surface facing the one of the plurality of second side edges in the first direction; and
a second surface opposite the first surface in the first direction, and
wherein the first frame is in contact with the second surface of the second frame.

16. The electrode plate transfer device of claim 1, wherein the plurality of side edges comprise:
a plurality of first side edges extending in a first direction and having a first length; and
a plurality of second side edges extending in a second direction intersecting the first direction, and having a second length the same as or different from the first length, and
wherein the first frame faces one of the plurality of first side edges and one of the plurality of second side edges, and forms entirety of the outer bent surface.

17. The electrode plate transfer device of claim 16, wherein the second frame faces the one of the plurality of first side edges and the one of the plurality of second side edges, and forms entirety of the inner bent surface.

18. The electrode plate transfer device of claim 16, wherein the second frame comprises:
a (1-1)-th surface facing the one of the plurality of second side edges in the first direction;
a (1-2)-th surface facing the one of the plurality of first side edges in the second direction;
a (2-1)-th surface opposite the (1-1)-th surface in the first direction; and
a (2-2)-th surface opposite the (1-2)-th surface in the second direction, and
wherein the first frame is in contact with the (2-1)-th surface in the first direction, and is in contact with the (2-2)-th surface in the second direction.
